(19) United States
(12) Patent Application Publication
(10) Pub. No.: US 2019/0023215 A1
(43) Pub. Date: Jan. 24, 2019

(54) Film Laminate and Interior Trim Part for Motor Vehicles

(71) Applicant: Benecke-Kaliko AG, Hannover (DE)

(72) Inventors: Volker Huelsewede, Deggingen (DE); Joseph Mani, Eislingen (DE); Daniel Weber, Göppingen (DE)

(73) Assignee: Benecke-Kaliko AG, Hannover (DE)

(21) Appl. No.: 16/071,953

(22) PCT Filed: Feb. 6, 2017
(86) PCT No.: PCT/EP2017/052483

§ 371 Date: Jul. 23, 2018

(30) Foreign Application Priority Data
Apr. 15, 2016 (DE) 10 2016 206 340.5

(51) Int. Cl. B60R 21/215

(52) U.S. Cl. CPC B60R 21/215; B32B 5/18

(57) ABSTRACT

The invention relates to a film laminate (1) comprising at least a single- or multi-ply extruded decorative layer (2) having a lacquer layer (3) on its top side and a foam layer (4) on its bottom side. The invention further relates to an interior trim part for motor vehicles that is provided with such a film laminate (1). In deep-drawable film laminates (1) for coating of interior trim parts for a motor vehicle in the region of the airbag covers or in the region of the tear seams of the airbag covers which do not require weakening lines the film laminate (1) has a tensile strength according to DIN 527-3 type 5 at 2000 mm/min and 23° C. of 5 to 20 N/mm² in the extrusion direction and perpendicular to the extrusion direction and the ratio of the tear propagation force of the film laminate (1) in the extrusion direction to the tear propagation force of the film laminate (1) perpendicular to the extrusion direction is 0.85 to 1.2, wherein the tear propagation force is determined according to DIN EN ISO 34 method B, procedure b at 23° C.

The invention relates to a film laminate comprising at least a single- or multi-ply extruded decorative layer having a lacquer layer on its top side and a foam layer on its bottom side. The invention further relates to interior trim parts of motor vehicles provided with such a film laminate.

In the field of decorative film laminates for automotive interiors essentially two constructions are used at present.

For applications and components in which the film laminate is subjected to severe stretching (e.g. up to 300%) in downstream thermal forming processes it is preferable to use compact film constructions which may be constructed from a plurality of layers. Such compact films based on polyolefins are described in DE 10018196 A1 for example. In the production of an interior trim part of a motor vehicle, for example of a dashboard, the film construction is first subjected to thermoforming in a positive or negative deep drawing process. Subsequently, in a second processing step, the thus-produced “skin” is backfoamed with a generally PUR-based foam and this foam is joined to a stable carrier element.

For applications and components in which the film laminate is subjected to low stretching of (e.g. <200%) in downstream thermal forming processes film laminates having at least one foamed layer, so-called foam film laminates, may be employed. These consist of a single- or multi-ply decorative layer having a lacquer layer on its top side and a foam layer based on polyolefins on its bottom side. Such film laminates are mentioned at the outset. In the production of an interior trim part of a motor vehicle, for example of a dashboard, in this case the entire foam film laminate is first subjected to thermoforming in a positive or negative deep drawing process. The thus produced “foam skin” is subsequently joined to the stable carrier element with an adhesive. The advantage of these latter foam laminates is that they can be processed in a single-stage process to afford a molded, foamed component having the desired softness (desired haptics) provided via the foam. When using the former compact film construction this is achievable only with a backfoaming procedure downstream of the thermoforming.

The film laminates are used to produce components for automotive interiors, inter alia dashboards, in thermoforming processes. When film laminates are used in components containing an airbag function the film laminates must exhibit a required tearing behaviour, whereby deployment of the airbag must take place within defined time specifications, flying particles are avoided, and protection of the passenger is ensured. To achieve this, the current prior art provides for reverse side weakening (intended breaking site) of the foam film laminate generally using laser cutting. These introduced intended breaking sites (weakening lines) are either visible directly after introduction or become visible in the later use of the component. This visibility was perceived as a pronounced optical defect. In addition, acquisition and operation of the machines for the introduction of the weakening lines entails additional costs, which is why foam film laminates have hitherto been used only to a small extent for components having an airbag function.

Film laminates which comprise at least a single- or multi-ply extruded decorative layer having a lacquer layer on its top side and a foam layer on its bottom side, which may be used for dashboards, and which are said to eschew additional weakening lines, are known from EP 2 117 881 B1. In EP 2 117 881 B1 the covering layer (decorative layer) is said to comprise at least two plies with an outer ply and an inner ply, wherein the inner ply and the foamed layer have a breaking elongation which is substantially less than the breaking elongation of the outer ply of the decorative layer. In addition, for the inner ply, greater breaking elongation values are disclosed for breaking in the longitudinal direction than for breaking in the transverse direction. However, it became apparent that the film laminates recited in EP 2 117 881 B1 could not be employed for all geometries of airbag flaps without additional weakening lines needing to be introduced. Furthermore, in some cases the presence of the inner layer having a lower breaking elongation within the decorative layer resulted in a poorer deep drawing behaviour with a poorer grain image.

The problem addressed by the present invention is that of providing a film laminate which can be used as an interior trim part of motor vehicles, in particular in the region of airbag covers, and which requires no weakening lines. The film laminate shall also be amenable to processing in the deep drawing process, i.e. the stability of the film laminate shall be sufficient for thermal forming processes comprising a degree of stretching of up to 200%.

The problem is solved by a film laminate of the type described at the outset having a tensile strength according to DIN 527-3 type 5 at 2000 mm/min and 23° C. of 5 to 20 N/mm² in the extrusion direction (longitudinal direction) and perpendicular to the extrusion direction (transverse direction) and the ratio of the tear propagation force of the film laminate 1 in the extrusion direction (longitudinal direction) to the tear propagation force of the film laminate 1 perpendicular to the extrusion direction (transverse direction) is 0.85 to 1.2, wherein the tear propagation force is determined according to DIN EN ISO 34 method B, procedure b at 23° C.

In an airbag deployment, the so-called airbag detonation, a first breaking of the decorative layer is followed by tear propagation of the layer in the longitudinal direction of the production direction of the extruded film which is then followed by tear propagation in the transverse direction to open an airbag flap of rectangular shape for example. In conventional film laminates the tear propagation forces in the longitudinal direction are less than in the transverse direction due to the anisotropy brought about by the extrusion of the film and a contour-specific tearing along the airbag flap is therefore not possible. Since in the film laminate according to the invention the tear propagation forces in the transverse direction are in the same order of magnitude as the tear propagation forces in the longitudinal direction and the tensile strengths are at the low level of 5 to 20 N/mm², it is surprisingly possible to achieve a contour-specific opening of the airbag flap without any need to undertake a previous weakening of the laminate with intended breaking sites. This avoids any visibility of weakening lines which is regarded as a design flaw. The component producer also avoids costs relating to the purchase and operation of machines for introducing weakening lines.

In an advantageous development of the invention the decorative layer is a two-ply layer composed of an outer ply and of an inner ply adjacent to the foam layer. This construction allows for a better tailoring of the outer ply to the desired haptics and impression of the overall laminate and the inner ply may be further optimized in terms of tearing behaviour.

For a good deep drawability with the desired tensile strength coupled with pleasant haptics it has proven advantageous when the decorative layer has a thickness of 0.2 to 1 mm.

In addition the outer ply of the film laminate may preferably have a thickness of 0.1 to 0.5 mm and the inner ply adjacent to the foamed layer may likewise have a thickness of 0.1 to 0.5 mm.

The extruded decorative layer may be formed from plastic layers as a single- or multi-ply layer. The plastic may be selected for example from polyolefins, in particular thermoplastic polyolefins (TPO), polyurethane (PU), for example thermoplastic polyurethanes (TPU), styrene-ethylene-butylene-styrene copolymers (SEBS) or a combination of two or more thereof, wherein TPO is particularly preferable. The use of thermoplastic polyolefins (TPO) is widespread. Examples of polyolefins are polyethylene (PE), polypropylene (PP) and mixtures of polyethylene (PE) and polypropylene (PP).

The term polyethylene (PE) is herein to be understood as meaning polymers or copolymers whose weight fraction of ethylene is more than 50% by weight. The term polypropylene (PP) is herein to be understood as meaning polymers or copolymers whose weight fraction of propylene is more than 50% by weight.

The plastic of the decorative layer may contain customary additives such as for example lubricants, stabilizers, fillers, such as inorganic fillers and/or pigments.

To achieve the ideally isotropic behaviour in terms of the tear propagation forces with a longitudinal direction to transverse direction ratio of 0.85 to 1.2, various approaches are possible.

It is thus possible for the single- or multi-ply decorative layer to contain polar and nonpolar polymers within at least one ply. Due to the differing polarity of the polymers said polymers do not mix homogeneously and after extrusion of the film the polar polymers are arranged like spheres in the nonpolar matrix and thus weaken the tear propagation force perpendicular to the extrusion direction. Examples here include polar polymers in combination with thermoplastic vulcanizates (TPV), for example crosslinked EPDM.

It is thus also possible to achieve the approximation of isotropic tear propagation by targeted combination of high-viscosity and low-viscosity polymers having a viscosity/MFI difference of more than 6 g/10 min according to DIN EN ISO 1133 within at least one ply of the decorative layer. The high-viscosity polymers are thus arranged like elongated islands in the matrix of low-viscosity polymers. Examples here include a combination of low-viscosity LDPE with high-viscosity PP. Measurement of the MFI according to DIN EN ISO 1133 is carried out at 190° C./2.16 kg for PE, at 230° C./2.16 kg for PP and at 230° C./10 kg for TPV.

In a third option for achieving approximately equal tear propagation forces in the longitudinal direction and the transverse direction the single-ply or multi-ply decorative layer contains gas or air inclusions, preferably in the form of spherical hollow bodies, within at least one ply. The hollow bodies act as defects for tearing in the transverse direction. Said hollow bodies may be hollow glass spheres for example.

The three abovementioned solution approaches are employable within a laminate both in one or more plies and in any desired combinations. Thus it is possible for example for spherical hollow bodies to be present in a ply composed of a mixture of high-viscosity and low-viscosity polymers.

The foam layer of the film laminate may be based on the same plastics as the plies of the decorative layer but differs from the decorative layer in terms of foaming and thus in terms of density. A polyolefin-based form is preferably concerned. The foam layer of the film laminate can be foamed either chemically by addition of a solid chemical blowing agent into the polymer composition or physically. The polymer composition for the foam layer may contain further customary constituents, such as blowing agents, lubricants, stabilizers, fillers, such as inorganic fillers, and/or pigments.

The foam layer of the film laminate preferably has a thickness of 0.5 to 4 mm and a density of 40 to 200 kg/m³. Such a film laminate may be subjected to deep drawing without disruptions in the foam layer.

The film laminate according to the invention comprises a lacquer layer on the smooth or three-dimensionally structured surface of the decorative layer. The lacquer layer may be advantageous for improving surface properties, for examples in terms of visual appearance or scratch resistance. The lacquer layer can be applied to the surface by conventional measures. The lacquer layer is preferably a polyurethane lacquer layer.

The production of the film laminate is carried out by customary processes, wherein the decorative layer is extruded and provided with a lacquer layer. The foamed layer is preferably formed by foam extrusion, wherein foaming may be performed by physical means (H₂O or inert gases) or using chemical blowing agents. The layers are then joined, for example thermally or by adhesive bonding, to afford a sheetlike material, thus producing a film laminate comprising a decorative layer and a foam layer. It is also possible to apply the lacquer layer after the joining of the two other layers.

These sheetlike laminates are subjected to further processing to afford components.

Various processes for forming components with a three-dimensionally structured surface are known from the prior art. One example thereof is the “in-mold graining process (IMG process”, which has developed as a special process from the negative deep drawing process. This in-mold graining process is probably best described as “negative deep drawing with graining”. Unlike the standard deep drawing process in which the three-dimensional geometric structure is molded into the component by introducing into the film a deep drawing ram that forms the subsequent shape of the component, in the negative deep drawing process a film is drawn, for example by vacuum, into a female mold.

Negative deep drawing with graining is thus a particular form of negative deep drawing in which not only the geometric structure of the component but also the later grain structure is introduced into the tool surface as a negative.

The film laminate according to the invention is particularly suitable for and directed to the production of components by the IMG process or the positive deep drawing process.

The produced laminates for the positive deep drawing process may be subjected to a crosslinking step, in particular electron beam crosslinking, preferably after introduction of the three-dimensional surface structure.

The crosslinking of the laminate may be effected with high-energy radiation, preferably electron radiation. This results in very good grain stability in positive deep drawing and in very good deep drawing properties. The irradiation leads to crosslinking in the plastic.

The film laminate may have the shape of a component, wherein the component shape is preferably obtainable by applying the film laminate to a carrier having the component shape in a shape-conferring process step.

It is preferable to use the film laminate for the coating of components for the interior trim of motor vehicles, in particular at least in the region of the airbag covers or in the region of the tear seams of the airbag covers.

Surprisingly, the film laminate according to the invention can be used to produce in the deep drawing process an interior trim part for motor vehicles which has tear behaviour meeting the requirements during airbag opening, without any need to carry out a subsequent weakening of the film laminate or of the component. The weakening lines perceived as defects may be eschewed and the additional costs for introducing the weakening lines (machines, workforce, working hours) are no longer applicable.

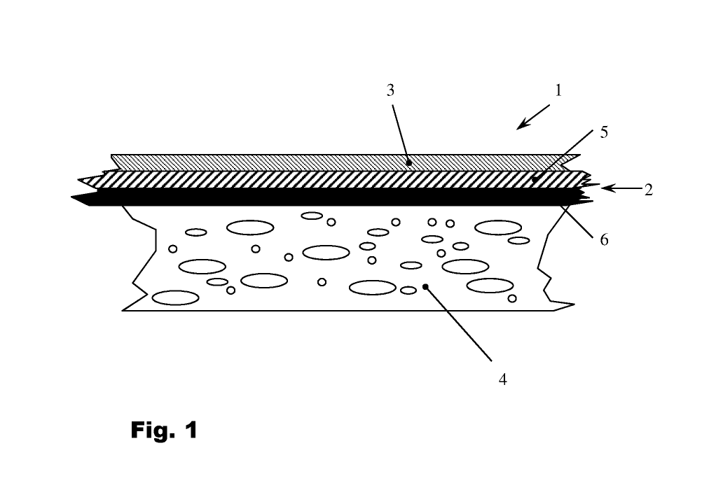

The invention will now be more particularly elucidated with reference to an exemplary embodiment and the sole FIG. 1 is a schematic diagram of the film laminate 1 according to the invention having a two-ply decorative layer 2 having an outer ply 5 and an inner ply 6 adjacent to the foam layer 4. Disposed on the outer ply 5 of the decorative layer 2 is a lacquer layer 3. The lacquer layer 3 has a thickness of 7 μm. The outer ply 5 and the inner ply 6 each have a thickness of 0.4 mm and the foam layer 4 is 2 mm thick. The film laminate 1 is provided with an embossed three-dimensionally structured surface on the decorative layer 2, i.e. with a grain embossed on the outside by roller embossing.

Such a film laminate may be used for the region of airbag covers in interior trims of motor vehicles without any need to provide weakening lines. It may be processed in the deep drawing process.

Film laminates having the abovementioned layer construction were produced, wherein the ply 6 of the decorative layer 2 was varied according to table 1, 2 and 3. The outer ply 5 used was always a ply suitable for the positive deep drawing process and composed of 33% by weight PP, 33% by weight of ethyl propyl rubber and 33% by weight of EPDM (weight percentages based on the polymers). The lacquer layer 3 was always a polyurethane lacquer, the foam layer 4 was a polyolefin-based foam having a density of 67 kg/m³. The film laminates were used to determine the tear propagation forces in the extrusion direction (longitudinal direction) and perpendicular to the extrusion direction (transverse direction) according to DIN EN ISO 34 method B procedure b at 23° C. and the tensile strengths according to DIN 527-3 type 5 at 2000 mm/min and 23° C. in the longitudinal direction and the transverse direction.

Inventive laminates are labeled I and comparative laminates are labeled C.

The ingredients were as follows:
TPV: PP/EPDM blend with 50% by weight EPDM, MFI 15 g/10 min (230° C./10 kg), softening point about 165° C.
Polar polymer: polylactic acid, density 1.2 g/ccm³, m.p. 145-160° C., MFI 19 g/10 min (230° C./2.16 kg)
Compatibilizer 1: acrylate-based terpolymer
Compatibilizer 2: high-viscosity LLD-PE (MFI 1 g/10 min (190° C./2.16 kg))
High-viscosity LDPE: low-density polyethylene, MFI=1.9 g/10 min at 190° C./2.16 kg
Low-viscosity PP: propylene homopolymer, MFI=10.0 g/10 min at 230° C./2.16 kg, melt elasticity 7 cN at an elongation rate of 250 mm/s measured at a temperature of 200° C.
Low-viscosity LDPE: low-density polyethylene, MFI=9 g/10 min at 190° C./2.16 kg
High-viscosity PP: propylene homopolymer, MFI=1.0 g/10 min at 230° C./2.16 kg
Hollow glass spheres, diameter 35 μm

The melt flow index (MFI) as used here is determined according to DIN EN ISO 1133 at a temperature of 230° C. for PP and 190° C. for PE and a load of 2.16 kg. The terms melt flow index (MFI) and melt flow rate (MFR) are used synonymously.

TABLE 1

| | Unit | 1(C) | 2(C) | 3(I) | 4(I) |
|---|---|---|---|---|---|
| Constituents | | | | | |
| TPV | parts by | 90 | 90 | 80 | 70 |
| | weight | | | | |
| polar polymer | parts by | 10 | 10 | 20 | 30 |
| | weight | | | | |
| compatibilizer | parts by | — | 5 | 5 | 5 |
| | weight | | | | |
| Properties | | | | | |
| longitudinal tear propagation | N | 8 | 10 | 11 | 12 |
| force | | | | | |
| transverse tear propagation | N | 11 | 12 | 11 | 13 |
| force | | | | | |
| longitudinal/transverse tear | | 0.7 | 0.8 | 1 | 0.9 |
| propagation force ratio | | | | | |
| longitudinal tensile strength | N/mm² | 15 | 12 | 7 | 5 |
| transverse tensile strength | N/mm² | 18 | 15 | 8 | 5 |

According to table 1 two immiscible polymers were employed in the inner ply 6 of the decorative layer to achieve similar tear propagation forces in the longitudinal direction and the transverse direction. Airbag detonations performed with the film laminates 3(I) and 4(I) afforded good results even without weakening lines.

TABLE 2

| | Unit | 5(C) | 6(I) | 7(C) | 8(C) | 9(I) | 10(C) |
|---|---|---|---|---|---|---|---|
| Constituents | | | | | | | |
| low-viscosity | parts by | 40 | 70 | 80 | — | — | — |
| LDPE | weight | | | | | | |
| high-viscosity PP | parts by | 40 | 10 | 10 | — | — | — |
| | weight | | | | | | |
| high-viscosity | parts by | — | — | — | 40 | 70 | 80 |
| LDPE | weight | | | | | | |
| low-viscosity PP | parts by | — | — | — | 40 | 10 | 10 |
| | weight | | | | | | |
| compatibilizer 2 | parts by | 20 | 20 | 10 | 20 | 20 | 10 |
| | weight | | | | | | |
| Properties | | | | | | | |
| longitudinal tear | N | 25 | 14 | 16 | 30 | 19 | 28 |
| propagation force | | | | | | | |
| transverse tear | N | 62 | 15 | 33 | 70 | 20 | 30 |
| propagation force | | | | | | | |
| longitudinal/ | | 0.4 | 0.9 | 0.5 | 0.4 | 0.9 | 0.9 |
| transverse | | | | | | | |
| tear propagation | | | | | | | |
| force ratio | | | | | | | |
| longitudinal tensile | N/mm² | 15 | 13.5 | 27 | 29 | 13 | 24 |
| strength | | | | | | | |
| transverse tensile | N/mm² | 18 | 15 | 32 | 33 | 14 | 27 |
| strength | | | | | | | |

According to table 2 high-viscosity polymers and low-viscosity polymers were employed simultaneously in the inner ply 6 of the decorative layer to achieve similar tear propagation forces in the longitudinal direction and the transverse direction. Airbag detonations performed with the film laminates 6(I) and 9(I) afforded good results even without weakening lines.

TABLE 3

| | Unit | 11(I) |
|---|---|---|
| Constituents | | |
| high-viscosity LDPE | parts by weight | 97.5 |
| hollow glass spheres | parts by weight | 2.5 |
| Properties | | |
| longitudinal tear propagation force | N | 26 |
| transverse tear propagation force | N | 27 |
| longitudinal/transverse tear propagation | | 0.9 |
| force ratio | | |
| longitudinal tensile strength | N/mm² | 9.2 |
| transverse tensile strength | N/mm² | 11 |

According to table 3 hollow glass spheres having a diameter of 35 μm were admixed into the polymer of the inner ply 6 to achieve similar tear propagation forces in the longitudinal direction and the transverse direction. Airbag detonations performed with the film laminate 11(I) afforded good results even without weakening lines.

1.-10. (canceled)

11. A film laminate comprising a single-ply extruded decorative layer having a lacquer layer on a top side and a foam layer on a bottom side, wherein the film laminate has a tensile strength according to DIN 527-3 type 5 at 2000 mm/min and at 23° C. of 5 to 20 N/mm² in an extrusion direction, wherein the film laminate has a ratio of a tear propagation force in the extrusion direction relative to a tear propagation force perpendicular to the extrusion direction of from 0.85 to 1.2, and wherein the tear propagation force is determined according to DIN EN ISO 34 method B, procedure b at 23° C.

12. The film laminate as claimed in claim 11, wherein the decorative layer has a thickness of 0.2 to 1 mm.

13. The film laminate as claimed in claim 11, wherein the decorative layer has a thickness of 0.1 to 0.5 mm.

14. The film laminate as claimed in claim 11, wherein the single-ply decorative layer comprises polar and nonpolar polymers.

15. The film laminate as claimed in claim 11, wherein the single-ply decorative layer comprises polymers having a viscosity difference/MFI difference of more than 6 g/10 min according to DIN EN ISO 1133.

16. The film laminate as claimed in claim 11, wherein the single-ply decorative layer comprises spherical hollow bodies.

17. The film laminate as claimed in claim 11, wherein the foam layer has a thickness of 0.5 to 4 mm and a density of 40 to 200 kg/m³.

17. The film laminate as claimed in claim 11, wherein the ratio of a tear propagation force in the extrusion direction relative to a tear propagation force perpendicular to the extrusion direction is from 0.9 to 1.0.

18. The film laminate as claimed in claim 11 incorporated into a motor vehicles airbag cover and/or in a region of tear seams of an airbag cover.

19. A film laminate comprising a multi-ply extruded decorative layer having a lacquer layer on a top side and a foam layer on a bottom side, wherein the film laminate has a tensile strength according to DIN 527-3 type 5 at 2000 mm/min and at 23° C. of 5 to 20 N/mm² in an extrusion direction, wherein the film laminate has a ratio of a tear propagation force in the extrusion direction relative to a tear propagation force perpendicular to the extrusion direction of from 0.85 to 1.2, wherein the tear propagation force is determined according to DIN EN ISO 34 method B, procedure b at 23° C.

20. The film laminate as claimed in claim 19, wherein the decorative layer is a two-ply layer composed of an outer ply and of an inner ply adjacent to the foam layer.

21. The film laminate as claimed in claim 19, wherein the decorative layer has a thickness of 0.2 to 1 mm.

22. The film laminate as claimed in claim 20 wherein the outer ply has a thickness of 0.1 to 0.5 mm.

23. The film laminate as claimed in claim 20, wherein the inner ply adjacent to the foamed layer has a thickness of 0.1 to 0.5 mm.

24. The film laminate as claimed in claim 19, wherein the multi-ply decorative layer contains polar and nonpolar polymers within at least one ply.

25. The film laminate as claimed in claim 19, wherein the multi-ply decorative layer contains polymers having a viscosity difference/MFI difference of more than 6 g/10 min according to DIN EN ISO 1133 within at least one ply.

26. The film laminate as claimed in claim 19, wherein the multi-ply decorative layer contains spherical hollow bodies within at least one ply.

27. The film laminate (1) as claimed in claim 19, wherein the foam layer has a thickness of 0.5 to 4 mm and a density of 40 to 200 kg/m³.

28. The film laminate as claimed in claim 11, wherein the ratio of a tear propagation force in the extrusion direction relative to a tear propagation force perpendicular to the extrusion direction is from 0.9 to 1.0.

29. The film laminate as claimed in claim 19 incorporated into a motor vehicles airbag cover and/or in a region of tear seams of an airbag cover.
